(19) United States
(12) Patent Application Publication
(10) Pub. No.: US 2016/0215839 A1
(43) Pub. Date: Jul. 28, 2016

(54) METHOD FOR PRODUCING A BRAKE DISK AND BRAKE DISK

(71) Applicant: FORD GLOBAL TECHNOLOGIES, LLC, Dearborn, MI (US)

(72) Inventors: Ivan Jan Mathieu Ernest Bruggen, Riemst (BE); Tomasz Pawel Grabiec, Bergisch Gladbach (DE); Clemens Maria Verpoort, Monheim am Rhein (DE)

(21) Appl. No.: 14/904,603

(22) PCT Filed: Jun. 27, 2014
(86) PCT No.: PCT/EP2014/063643

§ 371 Date: Jan. 12, 2016

(30) Foreign Application Priority Data
Jul. 15, 2013 (DE) 102013213790.7

(51) Int. Cl. F16D 65/12; C23C 2/04; C25D 11/26; C25D 11/02; C25D 11/04; C23C 2/12; C23C 2/26

(52) U.S. Cl. CPC F16D 65/127; C23C 2/12; C23C 2/04; C23C 2/26; C25D 11/026; C25D 11/04; C25D 11/26

(57) ABSTRACT

A method is provided for producing a brake disk for a vehicle. For this purpose, a protective layer that has an oxide layer is arranged on a base body of the brake disk. According to the invention, the method comprises the following steps:
providing a base body, preferably of iron, in particular of cast iron;
applying a metallic coating, at least in certain regions, to a surface of the base body;
creating a metallic connection between the metallic coating and the surface of the base body;
forming the oxide layer on the metallic coating that is metallically connected to the surface of the base body.

The invention is also directed to a brake disk for a vehicle.

### TECHNICAL FIELD

The present invention relates to a method for producing a brake disk for a vehicle, and also to a brake disk for a vehicle.

### BACKGROUND

In vehicles, in particular motor vehicles, disk brakes are the most widely used type of brake system. Disk brakes are made up mainly of a brake disk and a brake caliper surrounding the edge of the brake disk. The brake disk is connected here to the wheel of the vehicle to be braked by way of a wheel hub mounted rotatably in the knuckle. By contrast, the brake caliper is fixed to the knuckle. The actual deceleration is achieved by brake pads that can be applied to the brake disk and are arranged on both sides of the brake disk, between it and the brake caliper.

Depending on the application, brake disks may consist both of iron and of carbon-ceramic or aluminum. At the same time, brake disks should have a surface that wears as little as possible and gives off only a low amount of fine dust. To achieve this, the aim is to have a surface that is as hard as possible. Thus, for example in the case of brake disks of aluminum, particles of hard material, such as for example of silicon carbide (SiC), are correspondingly added, providing a wear-resistant surface. However, the production of brake disks from materials that do not contain iron is sometimes difficult and is usually cost-intensive.

Another way of forming such a protective layer may be achieved by thermal spraying. This involves the material that is to be applied to the surface of a base body of the brake disk being pre-softened by the effect of heat and accelerated in the form of individual particles by way of a stream of gas. When the particles impinge, a purely mechanical connection is created, without the surface of the base body melting. The materials may be metals or oxide-ceramic or carbidic materials. Apart from the high costs, a disadvantage here in particular is the durability of such protective layers. Usually only moderate roughening of the surface by means of corundum jets is possible, which does not lead to a permanently durable mechanical connection. Especially when using hard cast iron for the base body, it is not possible for example to carry out a dovetail form of roughening that is advantageous per se.

EP 1 432 849 A1 or WO 03/029529 A1 discloses a method for creating a protective layer on a component of light metal. The metallic component is in this case mainly formed from aluminum or magnesium or from a combination of these materials. Proposed for this is the use of an anodizing solution, in which the metallic component is placed. In order to form the protective layer, an electric current or a pulsed direct current flows through the solution between the component (anode) and a cathode. In this case, the average voltage is a maximum of 125 V. Alternatively, alternating current flows through the solution between the anode and the cathode. The solution itself contains water and a water-soluble complex fluoride or oxyfluoride of an element of the group consisting of titanium (Ti), zirconium (Zr), silicon (Si) and also a combination thereof. Furthermore, the water-soluble complex fluoride or oxyfluoride may also contain hafnium (Hf), tin (Sn), germanium (Ge), boron (B) and also a combination of all the aforementioned elements. Moreover, the solution may also comprise an inorganic acid or a salt and also fluorine, the solution then however not containing any of the elements titanium (Ti), zirconium (Zr), hafnium (Hf), silicon (Si), germanium (Ge) or boron (B) in the water. In this case, the anodizing solution has a pH of around 3 to around 11.

EP 1 921 177 A2 is directed to a method for creating wear protection layers on barrier-layer-forming metals by means of laser treatment. Said metals are, in particular, aluminum, magnesium or titanium and also alloys and mixtures thereof. Use of the laser is intended to form an oxide layer on the surface of the metal in the presence of oxygen. In this case it is intended that a layer of the metal situated under the oxide layer to be formed is remelted, without thereby reacting with the oxygen.

According to DE 20 2008 010 896 U1, it is intended to provide a material, in particular a component, to be used in the area of mechanical engineering, in particular automobile construction, preferably as a component of internal combustion engines, in particular cylinders, cylinder barrels, pistons, camshafts, bucket tappets, valves, bearing points on connecting rods or the like. The material used for the component is based on a barrier-layer-forming metal or an alloy or mixture thereof. Also provided is a wear protection layer, which is formed on the basis of an oxide of the barrier layer. To obtain the oxide, an anodic oxidation of the surface of the material of the component is proposed for example. The oxidation may also be followed by a melting treatment, in particular a treatment comprising melting or remelting of the surface of the material.

The methods that are known in the prior art envisage the formation on the surface of the respective component of an oxide layer that is advantageous per se. This contributes to increasing the wear resistance and provides cathodic protection against further corrosive attack. For this purpose, the material of the component itself is subjected to a suitable procedure, by which the desired oxide layer can form on the basis of the respective material.

Since brake disks are mass-produced wearing articles, they are primarily made from iron, in particular from cast iron. At the same time, the formation of iron oxide however tends to be undesired. Thus, the formation of oxide on the basis of the iron is a corrosive process, which over time destroys the brake disk. Apart from the appearance, which is impaired even by flash rust, this not uncommonly leads to an acoustic impairment, which is manifested by unpleasant squealing.

In view of the prior art presented, the simple and durable production of brake disks as a mass-produced article still leaves room for improvement.

### SUMMARY

Against this background, the invention is based on the object of presenting a method for producing a brake disk for a vehicle that makes low-cost and nevertheless durable mass production possible. It is also intended to provide a brake disk for a vehicle which, apart from low-cost production, has in particular improved resistance to corrosive attack, but at the same time has high wear resistance.

The method-related and article-related parts of the object are achieved as disclosed herein.

It should be pointed out that the features and measures that are individually presented in the description that follows may be combined with one another in any technically meaningful way and show further refinements of the methods and articles. The description additionally characterizes and specifies the methods and articles, in particular in connection with the figures.

Presented below is a method according to the invention for producing a brake disk for a vehicle in which a protective layer is arranged on a base body of the brake disk. Said protective layer has in this case an oxide layer. According to the invention, the method comprises the following steps:
providing a base body, preferably of iron;
applying a metallic coating, at least in certain regions, to a surface of the base body;
creating a metallic connection between the metallic coating and the surface of the base body;
forming the oxide layer on the metallic coating that is metallically connected to the surface of the base body.

The particular advantage is firstly the low-cost use of iron for the base body of the brake disk to be produced. Even if the base body may for example be produced by machining on a lathe, it is preferably cast. The use of cast iron makes very simple shaping possible for the base body. It is particularly preferred for gray cast iron, in which the carbon is in the form of graphite, to be used here.

Furthermore, a metallic coating is applied to the base body thus obtained. The metallic coating should in this case be arranged at least in certain regions on the surface of the base body. The metallic coating is to be applied in particular to the region or regions of the base body that is/are later intended to have the advantageous oxide layer.

One of the main advantages of the present method is the creation of the metallic connection between the surface of the base body and the metallic coating. By contrast with thermal spraying, this is not a purely mechanical interlocking, but an intermetallic connection. A high-strength connection is thereby achieved between the metallic coating and the base body, a connection which gives a high wear resistance to the oxide layer that is subsequently to be formed. In order to create the metallic connection, the base body provided with the metallic coating may, for example, be heated to the extent that an intermetallic connection forms between its surface and the metallic coating.

Finally there is the formation of the oxide layer on the metallic coating that is metallically connected to the surface of the base body. The particular advantage of the oxide layer is firstly the increased wear resistance of the brake disk thus produced. Then there is a cathodic protection formed on the base body, which prevents corrosive attack. In this case, the microscopically rough surface of the oxide layer is conducive to the formation of a stable, permanent transfer film. As a result, the wear limit for such a brake disk, which otherwise lies between 60 000 km and 100 000 km, is increased. In addition to this there is the permanently improved appearance, which is accompanied by improved acoustics, as a result of the absence of the formation of flash rust.

An advantageous development of the basic concept provides that the metallic coating consists of aluminum (Al). The aluminum (Al) that is intermetallically connected to the iron of the base body then forms the basis for the oxide layer to be formed, which is then formed from an aluminum oxide. As an alternative to this, the metallic coating may also consist of titanium (Ti). In this case, the titanium (Ti), which is then intermetallically connected to the iron of the base body, forms the basis for the oxide layer to be formed, which is formed here from a titanium oxide. The advantage of using aluminum (Al) and/or titanium (Ti) oxides is that the oxide layer forming is well able to achieve high wear and corrosion protection values.

It is provided within the scope of the invention that the metallic coating can be applied by immersing the base body in a corresponding molten material. For this, firstly either molten aluminum (Al) and/or titanium (Ti) is provided. The base body is then at least partially immersed in said molten material, preferably under a shielding gas, whereby its surface is wetted at least in certain regions with the molten material. With particular preference, the base body is left in the molten material until the metallic connection between the base body and the metallic coating forms as a result of inward diffusion of the molten material.

Alternatively, the base body may of course also be first wetted with the molten aluminum (Al) and/or titanium (Ti). This is then followed for example by heating it in a furnace until the intermetallic connection between the base body and the metallic coating forms.

The advantage of immersion with the formation of the intermetallic connection can be seen in a simplified production process. The application of the metallic coating can take place with simultaneous formation of the intermetallic connection in a single station.

With preference, the base body provided with the metallic coating may also undergo finishing before the formation of the oxide layer. It goes without saying that any machining or material-removing operations in general may be performed on the base body before the application of the metallic coating. The finishing mainly comprises mechanical surface working. As a result, the metallic coating that is arranged on the base body and metallically connected to it is worked in such a way that a planar surface is obtained, in particular in the regions of the brake disk that are intended for contact with the brake pads. It is ensured by the surface working after the application of the metallic coating that is metallically connected to the base body that this coating cannot have any undesired changes in thickness. Changes in thickness of the brake disk could otherwise bring about juddering, in which some regions of the brake disk have increased contact with the brake pads approached.

If the metallic coating is aluminum (Al), the oxide layer of aluminum (Al) may be advantageously formed by means of Micro Arc Oxidation (MAO). Apart from its high temperature resistance and its large surface and also its advantageous acid-base properties, the aluminum oxide (Al₂O₃) that can be created in this way is distinguished by its good interaction with other metals. Micro Arc Oxidation (MAO) has the effect of improving the properties of the surface of the base body to the extent that, among other things, it increases in hardness and wear resistance. This process has the effect that the oxide layer of aluminum (Al) is converted into a dense ceramic layer attached by atomic bonding.

In the case of the alternative use of titanium-oxide coatings for the metallic coating, it is provided that the oxide layer to be formed thereon is advantageously formed by means of Plasma

Electrolytic Oxidation (PEO). The titanium oxide (TiO₂) that can be formed in this way likewise leads to an increase in the hardness and wear resistance of the base body of the brake disk. In the case of Plasma Electrolytic Oxidation (PEO), the surface of the metallic aluminum is correspondingly coated in a plasma discharge. Here, too, an oxide layer of titanium (Ti) is advantageously created as a dense ceramic layer attached by atomic bonding.

The present invention provides a method that is improved in comparison with the prior art for producing a wear-resistant and corrosion-protected brake disk. It is thus possible to retain the use of hard, low-cost iron for the base body in the form of cast iron, which is already advantageous per se. The subsequent uncomplicated immersion of the base body in molten aluminum (Al) and/or titanium (Ti) allows high cycle rates for production. As a result, the present method is ideally suited for the mass production of low-cost, wear- and corrosion-resistant brake disks. In particular, the intermetallic connection of the base body and the metallic coating that is initially to be formed allows a very solid base for the subsequent formation of the oxide layer on the basis of the material for the coating. Both Micro Arc Oxidation (MAO) and Plasma Electrolytic Oxidation (PEO) are reliable processes for the formation of the oxide layer, which are likewise ideally suited for mass production of the brake disks in question here.

In the following, the invention is also directed to a brake disk that is produced in particular by the method explained above. Subsequent statements concerning the present brake disk should accordingly be seen in connection with the present method, and so the features thereof can in principle be combined with those of the brake disk. Specifically:

The brake disk in question is preferably such a brake disk for a vehicle, in particular for a motor vehicle. The brake disk comprises a base body, on which a protective layer is arranged at least in certain regions. Said protective layer has in this case an oxide layer. According to the invention, the base body is produced from iron; with particular preference it is produced from cast iron, and so it has been shaped mainly by casting. In this case, the oxide layer is formed on a metallic coating that is metallically connected to a surface of the base body.

In other words, the advantageous oxide layer is formed here on a metallic coating of a different material than the material of the base body. In particular, the material for the metallic coating is a nonferrous material.

The advantages arising from the brake disk that has been presented above and the features that are described below have already been explained above in connection with the method and apply correspondingly to the brake disk.

An advantageous development of the brake disk according to the invention provides that the metallic coating may consist of aluminum (Al). The advantageous oxide layer is formed here from an aluminum oxide. Alternatively, the metallic coating may also consist of titanium (Ti). In this case, the advantageous oxide layer is formed from a titanium oxide.

In order to obtain the most planar possible surface of the base body that is provided with the metallic coating and is metallically connected thereto, the metallic coating is preferably surface-worked. It goes without saying that the base body may have already been prepared, for example by machining or grinding operations, before the application of the metallic coating. In the surface working of the coating, the latter is demonstrably changed in such a way that it is for example mechanically reduced in its application thickness at points of undesired thickening.

With respect to the application thickness of the oxide layer, it is provided that the oxide layer may have a thickness of 15.0 μm to 50.0 μm. With preference, the thickness of the oxide layer may have a thickness of 18.0 μm to 22.0 μm. With particular preference, the oxide layer has a thickness of 20.0 μm.

If the brake disk, that is to say the base body, consists of aluminum, an immersion bath could of course be unnecessary, while the further steps can be carried out either by means of MAO or PEO.

### BRIEF DESCRIPTION OF THE DRAWING FIGURES

Further advantageous details and effects of the invention are explained in more detail below on the basis of various exemplary embodiments that are represented in the figures, in which:

FIG. 1 shows a schematic representation of the present brake disk in a plan view.

FIG. 2 shows a partial section through the brake disk of FIG. 1 in the vertical direction.

FIG. 3 shows a cutout of a detail of an edge region of the brake disk from FIG. 2 in an enlarged and otherwise identical form of representation.

FIG. 4 shows the cutout of a detail from FIG. 2 with a modified surface of the brake disk.

FIG. 5 shows a flow diagram of the present method for producing a brake disk for a vehicle, in particular a motor vehicle.

In the various figures, the same parts are always provided with the same designations, and so they are generally also only described once.

### DETAILED DESCRIPTION

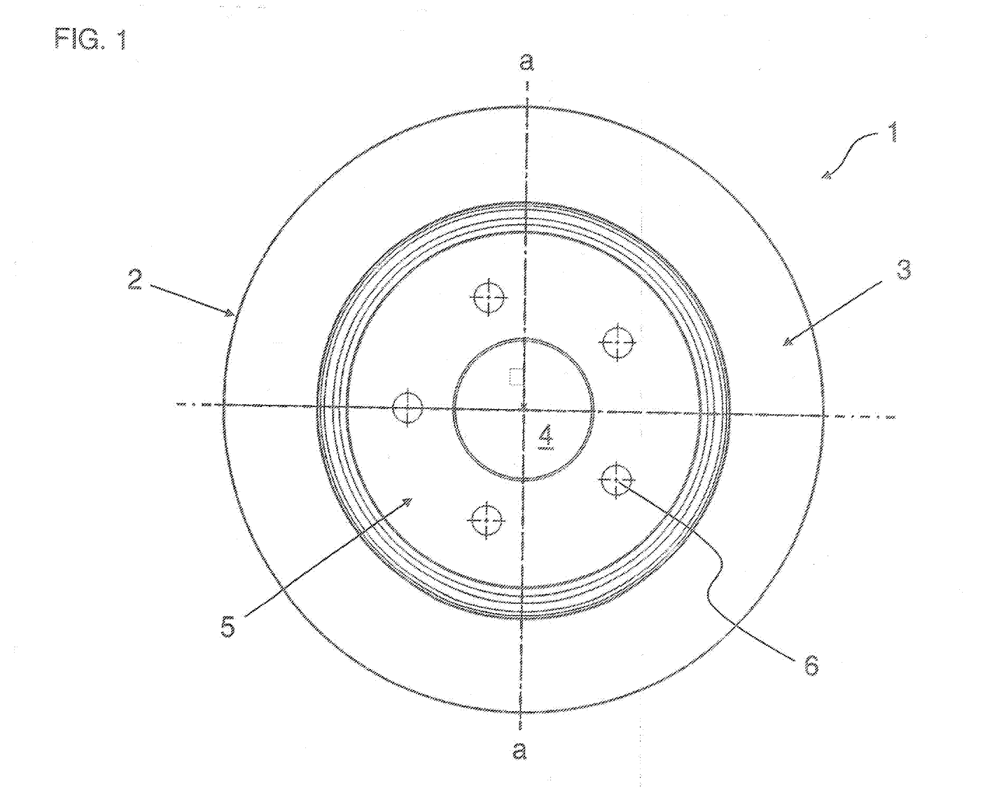

FIG. 1 shows a schematic representation of a brake disk 1 that is the subject matter of this document. This has a circular base body 2 of cast iron. The base body 2 typically has a peripheral outer brake rim 3, which is intended for contact with a brake pad, not represented any more specifically, of a brake caliper. Provided at the center of the base body 2 is an opening 4, which is arranged in a protrusion 5 of the base body 2. Arranged at uniform intervals around the opening 4 there are in the present case five passage holes 6 through the protrusion 5. Said passage holes 6 serve for receiving wheel bolts, not represented here, by way of which the brake disk 1 together with a wheel that is not shown can be connected to a wheel hub that is likewise not shown.

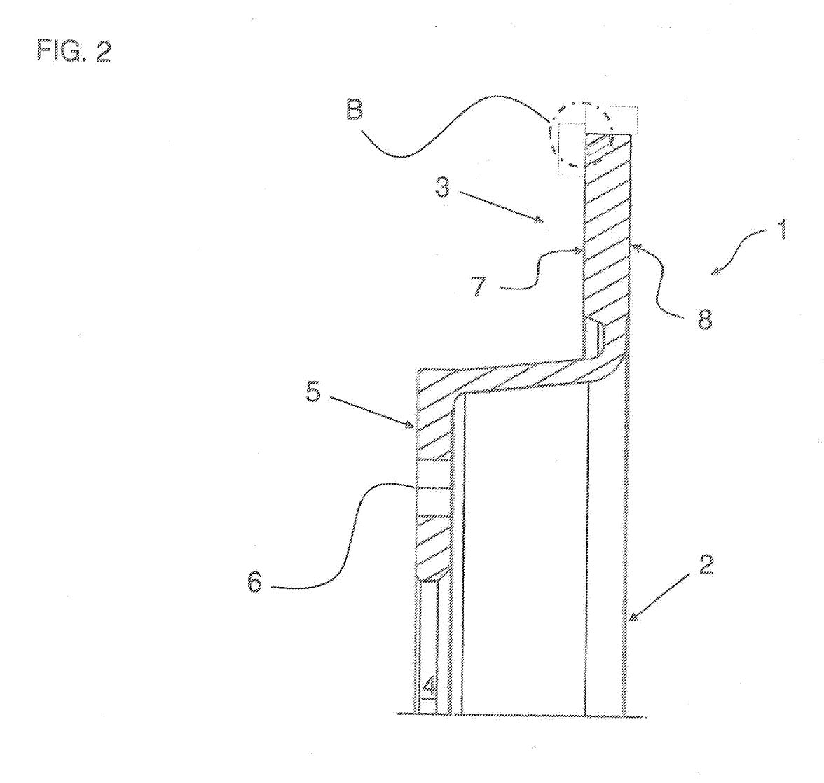

A plane a-a separates the brake disk 1 in its vertical with respect to the representation of FIG. 1, while FIG. 2 shows the view of a section through said plane a-a.

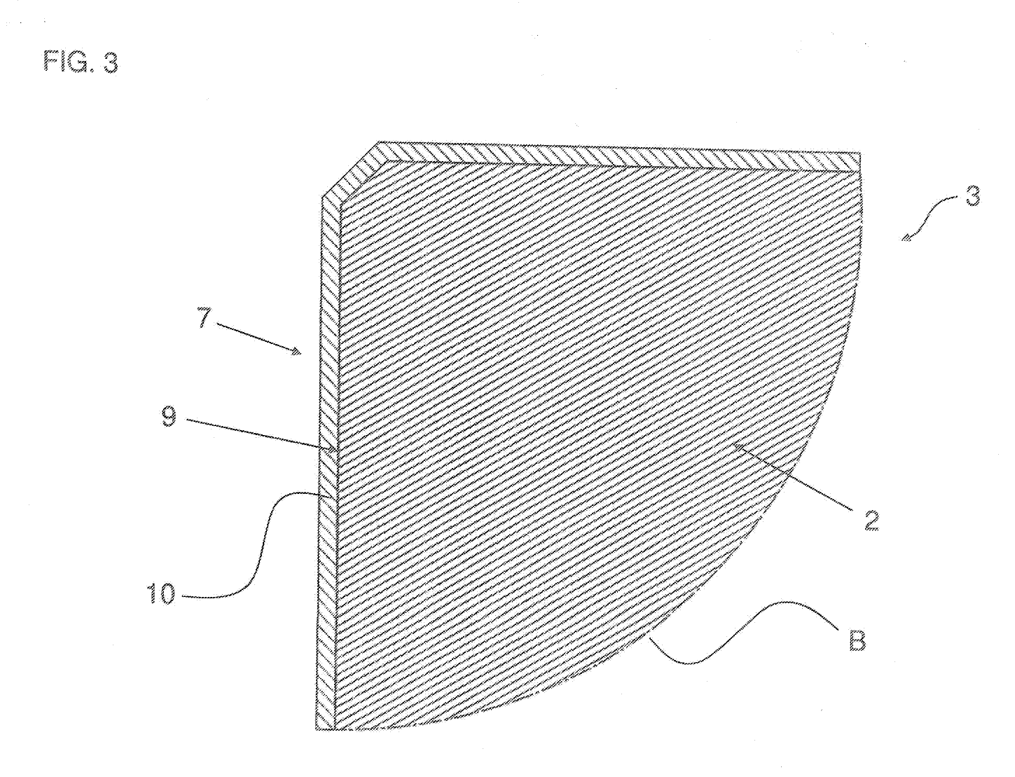

FIG. 2 shows a section through the plane a-a of the brake disk 1 from FIG. 1. As can be seen, the protrusion 5 protrudes from the brake rim 3 of the base body 2. The brake rim 3 comprises two braking areas 7, 8 aligned parallel to one another, to be more specific a first braking area 7 and a second braking area 8. The brake rim 3 has a dash-dotted circle B , the region of the brake rim 3 within the circle B being the content of FIG. 3.

FIG. 3 shows a cutout of a detail of the brake rim 3 from FIG. 2 within the circle B. It can be seen from the enlargement of the brake rim 3 in the region of its first braking area 7 that a metallic coating 10 has been applied on a surface 9 of the base body 2 in this region.

Furthermore, the metallic coating 10 has in a way that is not represented any more specifically a metallic connection to the surface 9 of the base body 2.

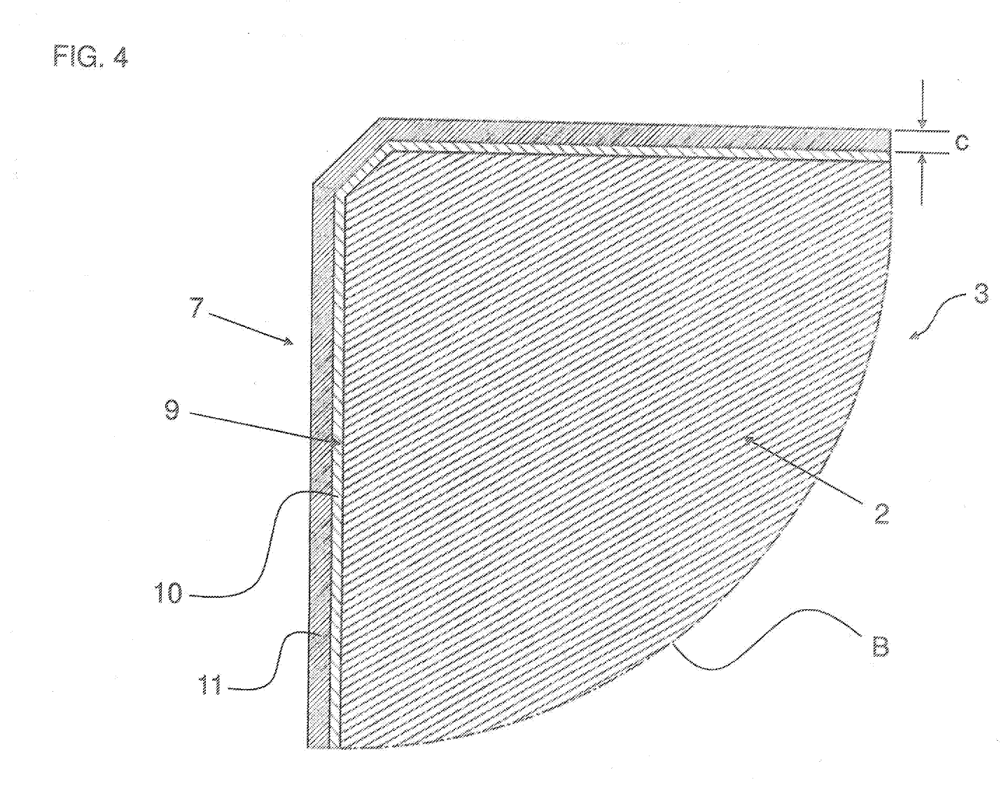

FIG. 4 shows the cutout of a detail from FIG. 3, an oxide layer 11 now having been formed on the metallic coating 10. The metallic coating 10 forms the base for this oxide layer 11.

In the present case, the metallic coating 10 consists of aluminum (Al). The advantageous oxide layer 11 is formed thereon from an aluminum oxide or a titanium oxide. In this case, the formed oxide layer 11 has a thickness c. The thickness c is in the present case 20.0 μm. In principle, the thickness c of the oxide layer 11 may be from 15.0 μm to 50.0 μm, in particular from 18.0 μm to 22.0 μm.

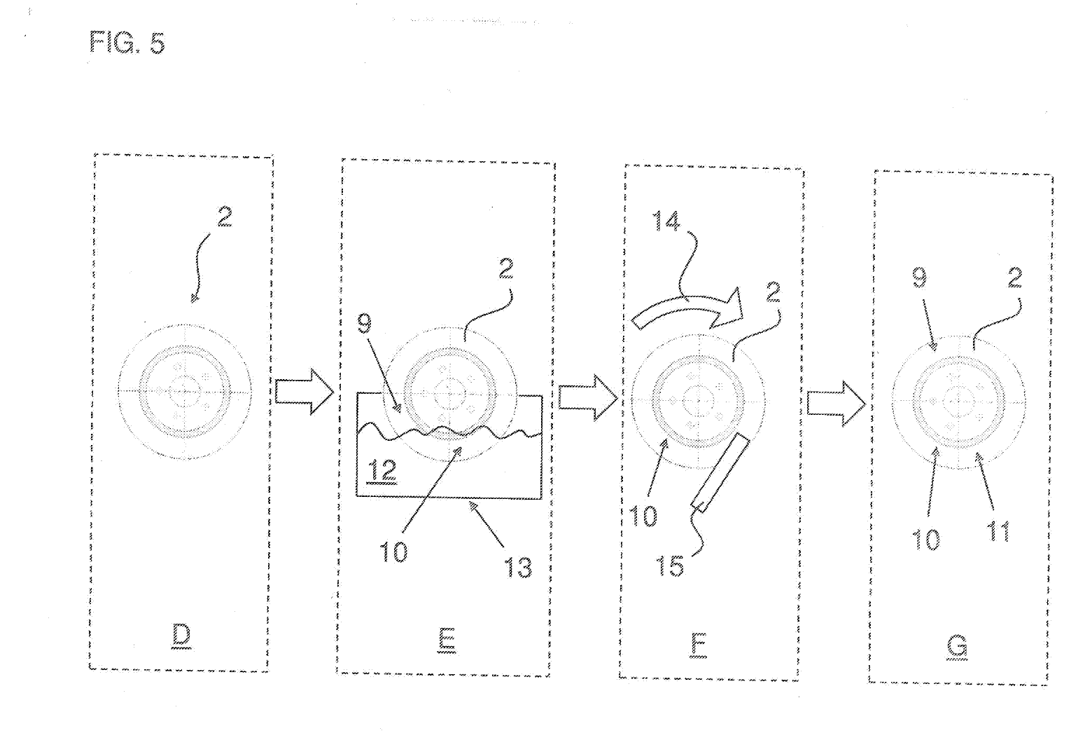

FIG. 5 shows the method for producing such a brake disk 1 in the form of a flow diagram. For this purpose, in a first step D, firstly the base body 2 is provided. This is formed from iron, preferably from cast iron, to be specific from gray cast iron.

In the subsequent second step E, the metallic coating 10 is applied at least in certain regions to the surface 9 of the base body 2. For this purpose, the base body 2 is immersed in molten aluminum (Al) 12. For this, the aluminum (Al) has previously been melted within a melting vessel 13 by the effect of heat. When the base body 2 is immersed in said molten material 12, an intermetallic connection is created between the surface 9 of the base body 2 and the metallic coating 10 of the molten material 12.

According to a subsequent third step F, it is provided that, if need be, the base body 2 provided with the metallic coating 10 is mechanically surface-worked before the oxide layer 11 forms. For this purpose, the base body 2 provided with the metallic coating 10 may for example be set in rotation 14 and worked by means of a machining or grinding tool 15.

In a final step G, the oxide layer 11 is formed on the metallic coating 10 that is mechanically connected to the surface 9 of the base body 2. Depending on the metal that is used for the metallic coating 10, the oxide layer 11 consists of an aluminum oxide or of a titanium oxide. On the metallic coating 10 of aluminum (Al), the oxide layer 11 is formed from aluminum oxide by means of Micro Arc Oxidation (MAO). On the metallic coating 10 of titanium, the oxide layer 11 is formed by means of a Plasma Electrolytic Oxidation (PEO).

What is claimed:

1. A method for producing a brake disk for a vehicle in which a protective layer that has an oxide layer is arranged on a base body of the brake disk, comprising:
applying a metallic coating, at least in certain regions, to a surface of the base body;
creating a metallic connection between the metallic coating and the surface of the base body;
forming the oxide layer on the metallic coating that is metallically connected to the surface of the base body,
wherein the metallic coating consists of aluminum (Al) or titanium (Ti) and the oxide layer is formed from an aluminum oxide or from a titanium oxide.

2. The method as claimed in claim 1, wherein the metallic coating is applied by immersing the base body in molten aluminum or titanium with formation of the metallic connection.

3. The method as claimed in claim 2, wherein the base body provided with the metallic coating is mechanically surface-worked before the oxide layer forms.

4. The method as claimed in claim 3, wherein the oxide layer of aluminum is formed by means of Micro Arc Oxidation (MAO).

5. The method as claimed in claim 3, wherein the oxide layer of titanium is formed by means of Plasma Electrolytic Oxidation (PEO).

6. The method as claimed in claim 1, wherein the base body provided with the metallic coating is mechanically surface-worked before the oxide layer forms.

7. The method as claimed in claim 1, wherein the oxide layer of aluminum is formed by means of Micro Arc Oxidation (MAO).

8. The method as claimed in claim 1, wherein the oxide layer of titanium is formed by means of Plasma Electrolytic Oxidation (PEO).

9. A brake disk for a vehicle, comprising a base body with a protective layer arranged at least in certain regions, the protective layer having an oxide layer, wherein
the oxide layer is formed on a metallic coating that is metallically connected to a surface of the base body, the metallic coating consisting of aluminum or titanium and the oxide layer being formed from an aluminum oxide or a titanium oxide.

10. The brake disk as claimed in claim 9, wherein the metallic coating is surface-worked.

11. The brake disk as claimed in claim 10, wherein the oxide layer has a thickness of 15 μm to 50 μm.

12. The brake disk as claimed in claim 10, wherein the oxide layer has a thickness of 18 μm to 22 μm.

13. The brake disk as claimed in claim 10, wherein the oxide layer has a thickness of about 20 μm.

14. The brake disk as claimed in claim 9, wherein the oxide layer has a thickness of 15 μm to 50 μm.

15. The brake disk as claimed in claim 9, wherein the oxide layer has a thickness of 18 μm to 22 μm.

16. The brake disk as claimed in claim 9, wherein the oxide layer has a thickness of about 20 μm.
